(19) United States
(12) Patent Application Publication
(10) Pub. No.: US 2015/0368513 A1
(43) Pub. Date: Dec. 24, 2015

(54) COVER WINDOW FOR DISPLAY DEVICE, DISPLAY DEVICE INCLUDING THE SAME, AND METHOD FOR MANUFACTURING THE SAME

(71) Applicant: Samsung Display Co., Ltd., Yongin-si (KR)

(72) Inventors: Yong Cheol JEONG, Yongin-si (KR); Seung Wook NAM, Cheonan-si (KR); Ji Hyuk IM, Seoul (KR)

(21) Appl. No.: 14/527,119

(22) Filed: Oct. 29, 2014

(30) Foreign Application Priority Data
Jun. 24, 2014 (KR) 10-2014-0077608

(51) Int. Cl. C09D 183/04

(52) U.S. Cl. CPC C09D 183/04

(57) ABSTRACT

A cover window, a display device, and a method of manufacturing a cover window, the cover window including a base film; and a coating layer on the base film, wherein the coating layer is formed by coating of a coating composition that includes at least one of an iodine-based initiator and a boric acid-based initiator.

### CROSS-REFERENCE TO RELATED APPLICATION

Korean Patent Application No. 10-2014-0077608, filed on Jun. 24, 2014, in the Korean Intellectual Property Office, and entitled: “Cover Window for Display Device, Display Device Including the Same, and Method for Manufacturing the Same,” is incorporated by reference herein in its entirety.

### BACKGROUND

1. Field

Embodiments relate to a window for a display device, a display device including the same, and a method for manufacturing a window for a display device.

2. Description of the Related Art

Mobile electronic devices include mobile phones, navigation systems, digital cameras, electronic books, portable game machines, and various terminals. The mobile electronic devices may include a liquid crystal display (LCD) or an organic light emitting diode (OLED) display applied as a display device.

A display device used in such mobile electronic devices may have a transparent window that is provided at the front of a display panel and through which a user may see a display unit. The window may be formed at the outermost position of the device, and the window may be resistant to external impact so as to protect the display panel inside the display device.

The above information disclosed in this Background section is only for enhancement of understanding of the background of the invention and therefore it may contain information that does not form the prior art that is already known in this country to a person of ordinary skill in the art.

### SUMMARY

Embodiments are directed to a window for a display device, a display device including the same, and a method for manufacturing a window for a display device.

The embodiments may be realized by providing a cover window including a base film; and a coating layer on the base film, wherein the coating layer is formed by coating of a coating composition that includes at least one of an iodine-based initiator and a boric acid-based initiator.

The coating composition may further include a monomer, and a solvent.

The monomer may include a compound represented by Formula 1:

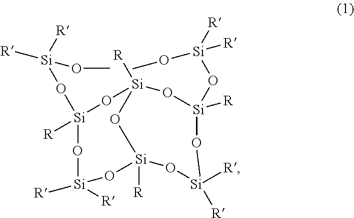

wherein, in Formula 1, R may be CH₃, and R′ may be an epoxy-containing group.

The coating composition may include the iodine-based initiator, the iodine-based initiator including a compound represented by Formula 2:

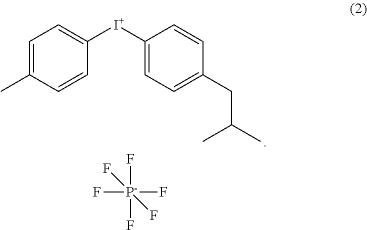 [SMILES: Cc1ccc([I+]c2ccc(CC(C)C)cc2)cc1 ; F[P-](F)(F)(F)(F)F]

The coating composition may include the boric acid-based initiator, the boric acid-based initiator including a compound represented by Formula 3:

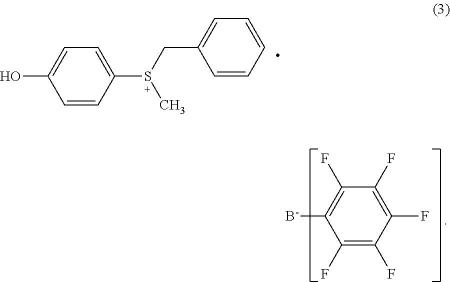

The coating composition may include the iodine-based initiator, the iodine-based initiator being a photo-hardening initiator.

The coating composition may include the boric acid-based initiator, the boric acid-based initiator being a photo-hardening and heat-hardening initiator.

The at least one of the iodine-based initiator and the boric acid-based initiator may be included in the coating composition in an amount of about 0.5 wt % to about 8.0 wt %, based on a total weight of the coating composition.

The monomer may be included in the coating composition in an amount of about 40 wt % to about 90 wt %, based on a total weight of the coating composition.

The solvent may include methyl ethyl ketone.

The embodiments may be realized by providing a display device including a display panel; and a cover window on the display panel, wherein the cover window includes a base film and a coating layer on the base film, the coating layer being formed by coating of a coating composition that includes at least one of an iodine-based initiator and a boric acid-based initiator.

The coating composition may further include a monomer, and a solvent.

The monomer may include a compound represented by Formula 1:

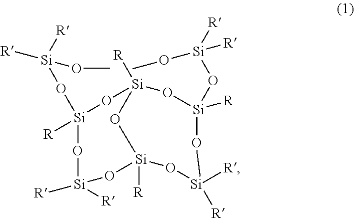

wherein, in Formula 1, R may be CH₃, and R′ may be an epoxy-containing group.

The coating composition may include the iodine-based initiator, the iodine-based initiator including a compound represented by Formula 2:

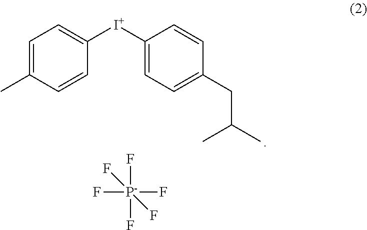 [SMILES: Cc1ccc([I+]c2ccc(CC(C)C)cc2)cc1 ; F[P-](F)(F)(F)(F)F]

The coating composition may include the boric acid-based initiator, the boric acid-based initiator including a compound represented by Formula 3:

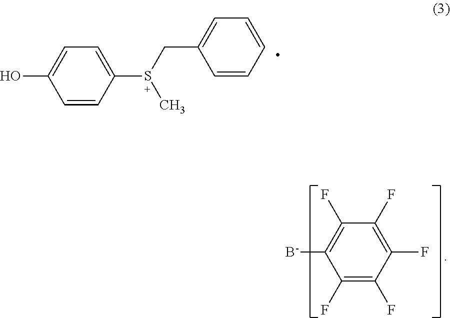

The coating composition may include the iodine-based initiator, the iodine-based initiator being a photo-hardening initiator.

The coating composition may include the boric acid-based initiator, the boric acid-based initiator being a photo-hardening and heat-hardening initiator.

The at least one of the iodine-based initiator and the boric acid-based initiator may be included in the coating composition in an amount of about 0.5 wt % to about 8.0 wt %, and the monomer may be included in the coating composition in an amount of about 40 wt % to about 90 wt %, all wt % being based on a total weight of the coating composition.

The embodiments may be realized by providing a method of manufacturing a cover window, the method including providing a base film; coating a coating composition on the base film; drying and hardening the coating composition; and annealing the hardened coating composition.

The annealing may be performed at a same humidity as the providing the base film, the coating the coating composition on the base film, or the drying and hardening the coating composition.

### BRIEF DESCRIPTION OF THE DRAWINGS

Features will be apparent to those of skill in the art by describing in detail exemplary embodiments with reference to the attached drawings in which:

FIG. 1 illustrates an exploded perspective view of a display device according to an exemplary embodiment.

FIG. 2 illustrates a cross-sectional view of a cover window according to an exemplary embodiment.

FIG. 3 illustrates stages in a manufacturing process of a cover window according to an exemplary embodiment.

FIG. 4 illustrates a yellowing index graph for an Exemplary Embodiment and a Comparative Example.

FIG. 5 illustrates a yellowing index graph for an Exemplary Embodiment and a Comparative Example.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

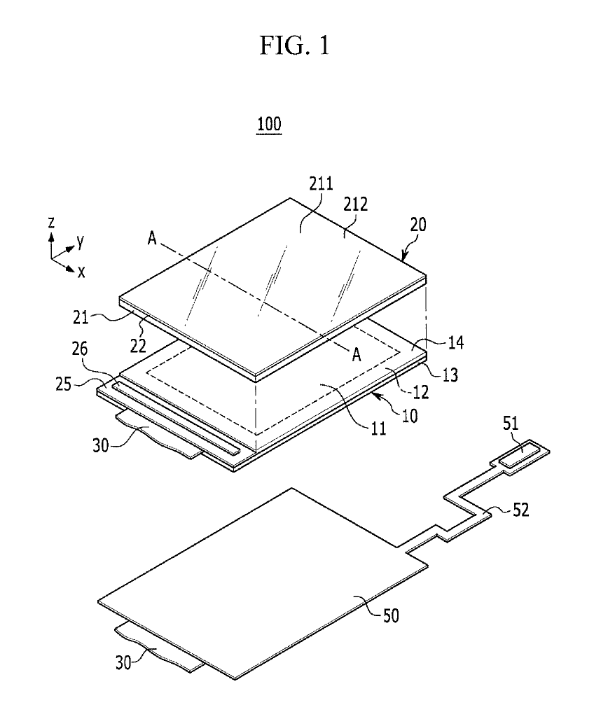

First, a display device according to an exemplary embodiment will be described with reference to FIG. 1.

FIG. 1 illustrates an exploded perspective view of a display device according to an exemplary embodiment.

Referring to FIG. 1, a display device 100 according to an exemplary embodiment may include a display panel 10 (for displaying images) and a cover window 20 on a front side of the display panel 10 and protecting the display panel 10.

In an implementation, the display panel 10 may be an organic light emitting panel. In another implementation, the display panel 10 may be another type of display, e.g., a liquid crystal display (LCD), and the display panel 10 may be a display panel including of a lower substrate, a field generating electrode, and a liquid crystal layer without a separate upper substrate. In the present exemplary embodiment, for convenience of description, the organic light emitting panel is described as an example.

The display panel 10 may be electrically connected to a printed circuit board (PCB) 50 through a flexible printed circuit 30.

Pixels, e.g., basic units for expressing an image, may be arranged in a matrix form on a first substrate 13 of the display panel 10, and a second substrate 14 may be bonded to the first substrate 13 through a sealing member (not shown) to protect the pixels. The first substrate 13 may be a rear substrate, and the second substrate 14 may be a front substrate.

For example, in an active matrix organic light emitting display panel, each pixel may include an organic light emitting element (not shown) including an anode electrode, an organic light emitting layer, and a cathode electrode, and a driving circuit unit (not shown) driving the organic light emitting element. The driving circuit unit may be a thin film transistor (TFT). A data line may be connected to a source terminal of the TFT, and a gate line may be connected to a gate terminal of the TFT. Either one of the anode electrode and the cathode electrode of the organic light emitting element may be connected to a drain terminal of the TFT.

The data line and the gate line may be connected to the PCB 50 through the flexible printed circuit 30. When an electrical signal is input to the source terminal and the gate terminal of the TFT through the PCB 50, the TFT may be turned on or off according to the signal input to output an electrical signal for driving pixels to the drain terminal.

An integrated circuit (IC) chip 26 may be mounted on the first substrate 13 to control the display panel 10. The IC chip 26 may generate timing signals for applying a data driving signal and a gate driving signal with appropriate timing. The IC chip 26 may apply the generated timing signals to the data line and the gate line of the display panel 10, respectively. A protective layer 25 may be formed around the IC chip 26 to protect the IC chip 26.

Electronic elements (not shown) for processing driving signals may be mounted on the PCB 50. The PCB 50 may include a connector 51 and an extending part 52. The extending part 52 may be installed in one end of the connector 51 to transmit an external signal to the PCB 50.

The cover window 20 (protecting the display panel 10) may be positioned in front of the display panel 10. The cover window 20 may protect the display panel 10 so that the display panel 10 may not be broken due to, e.g., external impact. The cover window 20 may be attached to the display panel 10 by an adhesive layer (not shown). In an implementation, the display panel 10 and the cover window 20 may be formed to be spaced from one another with an air layer formed therebetween.

The cover window 20 may include a base film 21 and a coating layer 22 on the base film 21.

The base film 21 may include a transparent part 211 in a region corresponding to or overlying the display unit 11 of the display panel 10 to allow the display unit 11 to be visible to the outside, and an opaque part 212 in a region corresponding to or overlying a non-display part 12 of the display panel 10 to prevent the non-display part 12 from being visible to the outside. The opaque part 212 may shroud wiring, components, or the like that are in the non-display part 12 of the display panel 10 such that they are invisible to the outside. The opaque part 212 may include, e.g., a logo of a product, a decorative pattern, or the like. In an implementation, the base film 21 may include the transparent part 211 and the opaque part 212, or the base film 21 may only include the transparent part 211.

The base film 21 may be made of, e.g., polyethylene terephthalate (PET), triacetyl cellulose (TAC), a polyimide (PI), a polycarbonate (PC), a thermoplastic polyurethane (TPU), or a silicon rubber.

The coating layer 22 may be formed by coating and hardening a coating composition on the base film 21. The coating layer 22 according to an exemplary embodiment may have hardness of more than a predetermined degree, thereby reducing a yellowing phenomenon that may be generated in the coating layer 22 by or in response to UV. The coating layer 22 will be described below.

The display device 100 according to the present exemplary embodiment may be formed of a material that is capable of being bent. For example, the display device 100 may be bent along the line A-A, and thus the cover window 20 may also be bent along the line A-A.

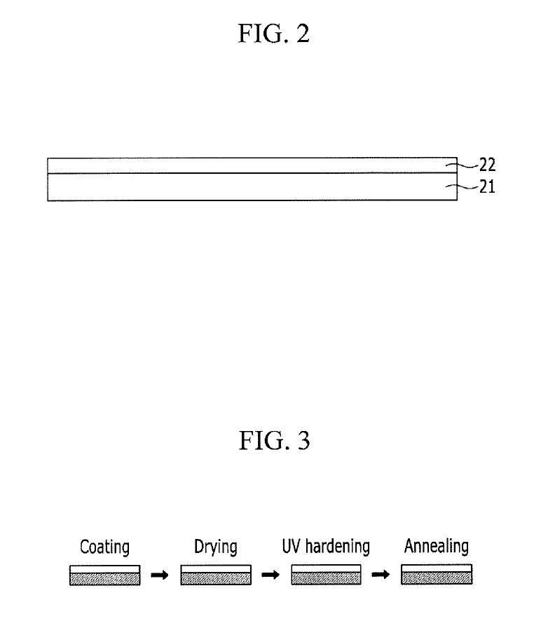

Next, the cover window 20 of the display device 100 according to an exemplary embodiment will be described with reference to FIG. 2.

FIG. 2 illustrates a cross-sectional view of a cover window 20 according to an exemplary embodiment. As shown in FIG. 2, the cover window 20 may include the base film 21 and the coating layer 22 on the base film 21.

In an implementation, the coating layer 22 may be only on the base film 21, or any shape of the cover window is possible. For example, a configuration described in the present specification may include the coating film, the base film, and the adhesive layer adhering the coating film and the base film.

The coating layer 22 according to an exemplary embodiment may be formed by coating and hardening the coating composition on the base film 21.

The coating composition according to an exemplary embodiment may include a monomer, an initiator, and a solvent.

The monomer according to an exemplary embodiment may be a hybrimer as an organic-inorganic hybrid material. In an implementation, the monomer may include a compound represented by Formula 1, below.

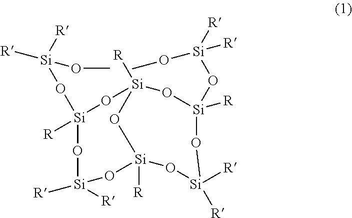

In Formula 1, R may be CH₃ and R′ may be an epoxy-containing group. The epoxy group of R′ may be ring-opened, and cross-linking may be realized through the ring-opened epoxy group.

The monomer may be included in the coating composition in an amount of about 40 wt % to about 90 wt %, e.g., about 60 wt %, based on a total weight of the coating composition.

The coating composition according to an exemplary embodiment may include the initiator, e.g., may include at least one of an iodine-based initiator and a boric acid-based initiator.

In an implementation, the iodine-based initiator may include a compound represented by Formula 2, below. In an implementation, the boric acid-based initiator may include a compound represented by Formula 3, below.

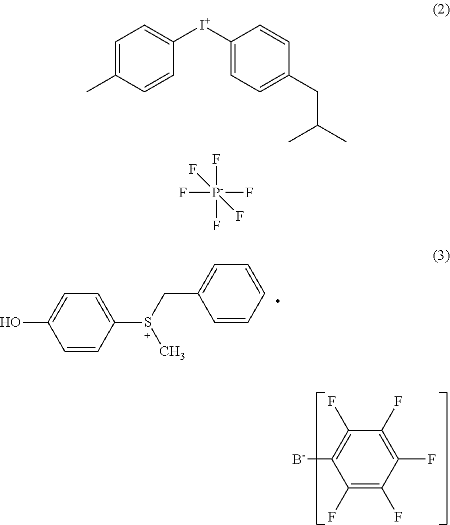

The iodine-based initiator may be photo-hardening. The boric acid-based initiator may be photo-hardening and heat-hardening. For example, the initiators may be activated by light or heat in a process of forming the coating layer, and the monomer may be polymerized by the activated initiator.

The initiator may be included in the composition in an amount of about 0.5 wt % to about 8.0 wt %, e.g., about 2 wt %. Including the initiator in the described amounts may help ensure that a reaction speed for the light or the heat is appropriately controlled.

The solvent according to an exemplary embodiment may include, e.g., methyl ethyl ketone (MEK).

The coating layer 22 formed from the described coating composition may not only have the hardness suitable for the outer surface of the display device, but may also help reduce and/or prevent the yellowing phenomenon generated by exposure to UV over a long time. For example, reliability and durability of the cover window may be improved.

FIG. 3 illustrates stages in a manufacturing process of a cover window according to an exemplary embodiment.

First, a base film 21 may be formed by using, e.g., polyethylene terephthalate (PET), triacetyl cellulose (TAC), a polyimide (PI), a polycarbonate (PC), a thermoplastic polyurethane (TPU), or a silicon rubber.

Next, a coating composition for forming the coating layer 22 may be coated on the base film 21 and may then be dried by heating, and then may be hardened through irradiation of UV.

Next, an annealing process may be performed on the hardened coating composition to form the coating layer 22. Here, if the annealing process does not require an additional high moisture condition, the annealing process may be performed in a common moisture condition. For example, the annealing process may be performed under the same humidity conditions (at the same humidity) as previously performed steps, such as the coating, drying, and/or UV hardening. Accordingly, the coating layer may be manufactured through the same (single-acting) equipment as the process of the coating and drying of the described coating composition. According to this manufacturing process, the manufacturing time and cost may be advantageously reduced.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

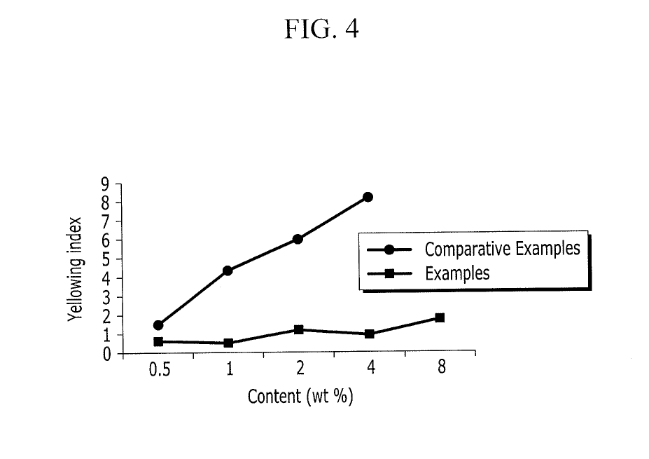

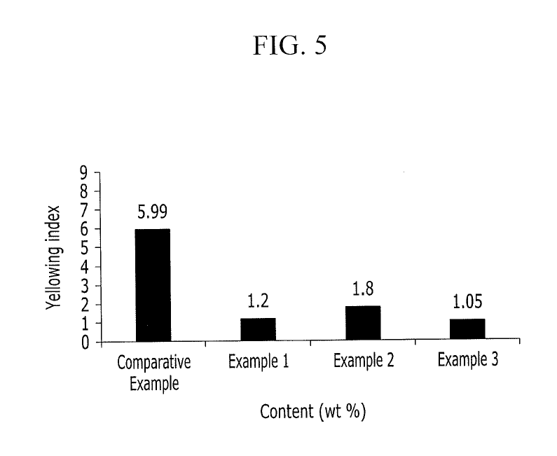

Next, a yellowing index for Examples and Comparative Examples will be described with reference to FIG. 4 and FIG. 5. The graph of FIG. 4 is based on Table 1, below, and the graph of FIG. 5 is based on Table 2, below.

First, referring to FIG. 4 and Table 1, the coating layer according to the Examples was formed using a coating composition that included the iodine-based initiator, and the coating layer of the Comparative Examples was formed using a coating composition that included a sulfur-based initiator.

As a result of examining the yellowing index (ΔYI) by differentiating the content of the initiator included in the coating composition, for the coating layer including the sulfur-based initiator of the Comparative Examples, as the content of the initiator is increased, the yellowing phenomenon noticeably appeared. When including the lowest content, it may be seen that the degree of the yellowing index of about 1.53 appeared.

In contrast, the change degree of the yellowing index according to the content of the initiator for the coating layer prepared using the coating composition including the iodine-based initiator was small. For example, the case in which the yellowing index of the largest value appeared (the content of the initiator was 8 wt %) was similar to the case that the lowest index value of the Comparative Examples (the content of the initiator is 0.5 wt %).

For example, when including the iodine-based initiator according to an exemplary embodiment, it may be seen that the yellowing phenomenon caused by UV may be remarkably reduced.

TABLE 1

| | Initiator | Coating layer | | | | ΔYI/ |
|---|---|---|---|---|---|---|
| | content | thickness | | | | coating layer |
| | (wt %) | (μm) | Y₀ | Y₁ | ΔYI | thickness |
| Comparative | 0.5 | 49 | 7.05 | 8.58 | 1.53 | 0.03 |
| Examples | 1 | 53 | 7.81 | 12.17 | 4.36 | 0.08 |
| | 2 | 50 | 7.93 | 13.92 | 5.99 | 0.12 |
| | 4 | 50 | 9.09 | 17.24 | 8.15 | 0.16 |
| Examples | 0.5 | Not cured | 7.56 | 8.2 | 0.64 | — |
| | 1 | 46 | 7.15 | 7.65 | 0.5 | 0.01 |
| | 2 | 48 | 7.06 | 8.26 | 1.2 | 0.025 |
| | 4 | 41 | 6.94 | 7.89 | 0.95 | 0.02 |
| | 8 | 45 | 7.04 | 8.78 | 1.74 | 0.04 |

Next, referring to Table 2 and FIG. 5, the Comparative Example is a case in which the coating layer was prepared from a coating composition including the sulfur-based initiator, and Example 1 is a case in which the coating layer was prepared from a coating composition including the iodine-based initiator. Example 2 is a case in which the coating layer was prepared from a coating composition including a boric acid-based initiator, and Example 3 is a case in which the coating layer was prepared from a coating composition including both the iodine-based initiator and the boric acid-based initiator.

TABLE 2

| | | Coating | | | | | |
|---|---|---|---|---|---|---|---|
| | Initiator | layer | | | | | |
| | content | thickness | | | | ΔYI/coating layer | Pencil |
| | (wt %) | (μm) | Y₀ | Y₁ | ΔYI | thickness | hardness |
| Comparative | 2 | 50 | 7.93 | 13.92 | 5.99 | 0.12 | 5 H |
| Example | | | | | | | |
| Example 1 | 2 | 48 | 7.06 | 8.26 | 1.2 | 0.025 | 2-3 H |
| Example 2 | 2 | 49 | 7.34 | 9.14 | 1.8 | 0.04 | 6 H |
| Example 3 | 1/1 | 49 | 6.78 | 7.83 | 1.05 | 0.02 | 5 H |

Referring to Table 2 and FIG. 5, compared with the Comparative Example, it may be seen that the yellowing index of the coating layer according to the Examples was remarkably decreased. For example, when including the iodine-based or the boric acid-based initiator, the yellowing phenomenon of the coating layer by the UV may be reduced and/or prevented.

As shown in Table 2, in Example 1, in which the coating composition included only the iodine-based initiator, the hardness may be somewhat decreased. As shown in Examples 2 and 3, in which the coating composition included the boric acid-based initiator, the hardness of a predetermined degree may be provided, thereby controlling the hardness as well as the reliability of the yellowing through the control of the content of the boric acid-based initiator.

By way of summation and review, a structure may use a touch panel having a display screen integrated therein. Thus, the surface of the window may be more frequently contacted with a finger or the like than mobile devices according to the related art, and the window may require higher strength.

Recently, a flexible device has been considered, and the cover window applied to the display device may be made of a member having flexibility such that it may be bent.

The embodiments may provide a cover window for a display device that helps reduce and/or prevent a yellowing phenomenon and that has surface hardness of more than a predetermined degree while being bent.

For example, by forming the coating layer according to an embodiment on the base film, the cover window may help suppress the yellowing phenomenon while also having surface hardness of the predetermined degree.

The coating layer according to an exemplary embodiment may not only have the hardness suitable for the outer surface of the display device, but may also reduce and/or prevent the yellowing phenomenon generated when being exposed to UV for a long time, thereby providing the cover window with improved reliability and durability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

### DESCRIPTION OF SYMBOLS

10: display panel 20: cover window
21: base film 22: coating layer
30: flexible printed circuit 50: printed circuit board (PCB)

What is claimed is:

1. A cover window, comprising:
a base film; and
a coating layer on the base film,
wherein the coating layer is formed by coating of a coating composition that includes at least one of an iodine-based initiator and a boric acid-based initiator.

2. The cover window as claimed in claim 1, wherein the coating composition further includes:
a monomer, and
a solvent.

3. The cover window as claimed in claim 2, wherein the monomer includes a compound represented by Formula 1: 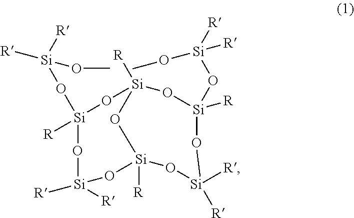
wherein, in Formula 1, R is CH₃, and R′ is an epoxy-containing group.

4. The cover window as claimed in claim 1, wherein the coating composition includes the iodine-based initiator, the iodine-based initiator including a compound represented by Formula 2:

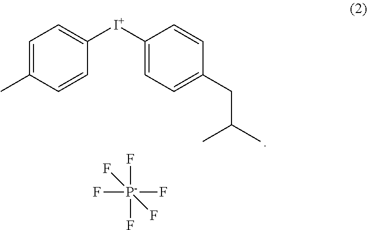 [SMILES: Cc1ccc([I+]c2ccc(CC(C)C)cc2)cc1 ; F[P-](F)(F)(F)(F)F]

5. The cover window as claimed in claim 1, wherein the coating composition includes the boric acid-based initiator, the boric acid-based initiator including a compound represented by Formula 3:

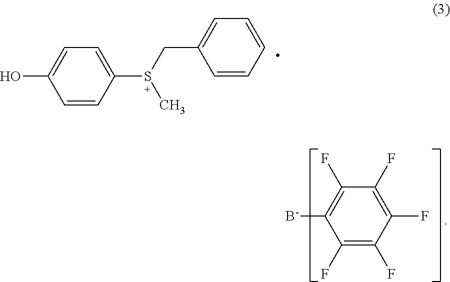

6. The cover window as claimed in claim 1, wherein the coating composition includes the iodine-based initiator, the iodine-based initiator being a photo-hardening initiator.

7. The cover window as claimed in claim 1, wherein the coating composition includes the boric acid-based initiator, the boric acid-based initiator being a photo-hardening and heat-hardening initiator.

8. The cover window as claimed in claim 2, wherein the at least one of the iodine-based initiator and the boric acid-based initiator is included in the coating composition in an amount of about 0.5 wt % to about 8.0 wt %, based on a total weight of the coating composition.

9. The cover window as claimed in claim 2, wherein the monomer is included in the coating composition in an amount of about 40 wt % to about 90 wt %, based on a total weight of the coating composition.

10. The cover window as claimed in claim 2, wherein the solvent includes methyl ethyl ketone.

11. A display device, comprising:
a display panel; and
a cover window on the display panel, wherein the cover window includes:
a base film and
a coating layer on the base film, the coating layer being formed by coating of a coating composition that includes at least one of an iodine-based initiator and a boric acid-based initiator.

12. The display device as claimed in claim 11, wherein the coating composition further includes:
a monomer, and
a solvent.

13. The display device as claimed in claim 12, wherein the monomer includes a compound represented by Formula 1: 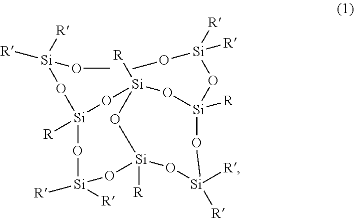
wherein, in Formula 1, R is CH₃, and R′ is an epoxy-containing group.

14. The display device as claimed in claim 11, wherein the coating composition includes the iodine-based initiator, the iodine-based initiator including a compound represented by Formula 2:

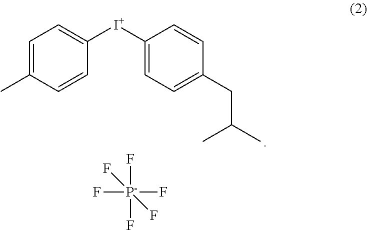 [SMILES: Cc1ccc([I+]c2ccc(CC(C)C)cc2)cc1 ; F[P-](F)(F)(F)(F)F]

15. The display device as claimed in claim 11, wherein the coating composition includes the boric acid-based initiator, the boric acid-based initiator including a compound represented by Formula 3:

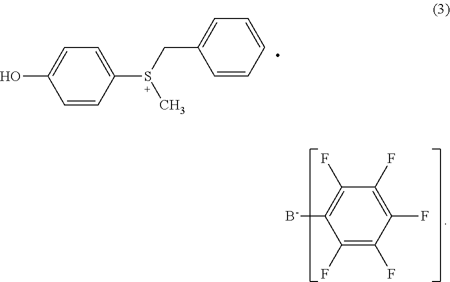

16. The display device as claimed in claim 11, wherein the coating composition includes the iodine-based initiator, the iodine-based initiator being a photo-hardening initiator.

17. The display device as claimed in claim 11, wherein the coating composition includes the boric acid-based initiator, the boric acid-based initiator being a photo-hardening and heat-hardening initiator.

18. The display device as claimed in claim 12, wherein:
the at least one of the iodine-based initiator and the boric acid-based initiator is included in the coating composition in an amount of about 0.5 wt % to about 8.0 wt %, and
the monomer is included in the coating composition in an amount of about 40 wt % to about 90 wt %, all wt % being based on a total weight of the coating composition.

19. A method of manufacturing a cover window, the method comprising:
providing a base film;
coating a coating composition on the base film;
drying and hardening the coating composition; and
annealing the hardened coating composition.

20. The method as claimed in claim 19, wherein the annealing is performed at a same humidity as the providing the base film, the coating the coating composition on the base film, or the drying and hardening the coating composition.
